(19) United States
(12) Patent Application Publication
(10) Pub. No.: US 2004/0224180 A1
(43) Pub. Date: Nov. 11, 2004

(54) Method of manufacturing oxide thin film, method of manufacturing ferroelectric thin film, ferroelectric thin film, ferroelectric memory device, and ferroelectric piezoelectric device

(75) Inventors: Takeshi Kijima, Matsumoto-shi (JP); Eiji Natori, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/724,635

(22) Filed: Dec. 2, 2003

(30) Foreign Application Priority Data
Dec. 2, 2002 (JP) 2002-349818

(51) Int. Cl. H01J 19/78

(52) U.S. Cl. 428/611; 315/55; 427/100

(57) ABSTRACT

A ferroelectric film manufactured by using a supercritical fluid. The supercritical fluid is a fluid which includes a ferroelectric element and is pressurized at a pressure ranging from the critical pressure to four times the critical pressure, for example.

Japanese Patent Application No. 2002-349818, filed on Dec. 2, 2002, is hereby incorporated by reference in its entirety.

### BACKGROUND OF THE INVENTION

In recent years, research and development of a ferroelectric thin film such as PZT or SBT, a ferroelectric capacitor using the ferroelectric thin film, and a ferroelectric memory device have been extensively conducted. The structure of the ferroelectric memory device is roughly divided into 1T, 1T1C (T: transistor, C: capacitor), 2T2C, and simple matrix. The 1T type ferroelectric memory device has a retention (data retention) as short as one month due to occurrence of an internal electric field in the capacitor from the viewpoint of its structure, and it is considered to be impossible to secure a 10-year guarantee generally required for semiconductors. Since the 1T1C and 2T2C type ferroelectric memory devices have almost the same configuration as the configuration of a DRAM and include a select transistor, the DRAM manufacturing technology can be utilized. Moreover, since the 1T1C and 2T2C type ferroelectric memory devices realize a write speed approximately equal to that of an SRAM, small-capacity products with a capacity of 256 kbits or less have been produced on a commercial basis.

As the ferroelectric material, Pb(Zr,Ti)O₃ (PZT) or SrBi₂Ta₂O₉ (SBT) is mainly used. Of these ferroelectric materials, SBT has a crystallization temperature as high as 700° C. or more. Therefore, vapor deposition technology such as an MOCVD method has been studied as the formation technology for the ferroelectric thin film which can reduce the crystallization temperature. However, the vapor deposition technology has problems relating to reproducibility and the like and has not been put into practical use. A sol-gel method or a sputtering method is generally used as the formation technology for the ferroelectric thin film. However, in the case of using the sol-gel method, 90 percent or more of the raw materials are wasted during spin coating.

A ferroelectric capacitor is generally formed by the process shown in FIG. 1.

An Si substrate on which CMOS transistors and the like are formed in advance is provided, and a Pt electrode is formed on the Si substrate through an adhesive layer such as TiOₓ. A ferroelectric thin film is formed on the Pt electrode by using the above-described thin-film formation technology, and a mask material such as SOG is formed in the area in which a capacitor is allowed to remain. The processing is then performed as shown in FIG. 1 using an ECR etcher mainly utilizing chlorine gas or the like.

Specifically, the formation technology shown in FIG. 1 uses the process in which the Pt electrode is formed over the entire Si wafer and an unnecessary area is removed after forming the ferroelectric thin film on the Pt electrode. A ferroelectric capacitor is formed by using various etching gases suitable for removing the SOG mask material, the ferroelectric thin film, the Pt electrode, and the TiOₓ adhesive film. Specifically, in the conventional formation technology, a capacitor is formed by repeating the complicated and wasteful process in which the material caused to adhere is removed. Moreover, since the conventional formation technology causes the characteristics of the ferroelectric to deteriorate during etching due to plasma and process damage, a heat treatment for causing the characteristics to recover from the damage is performed.

### BRIEF SUMMARY OF THE INVENTION

The present invention may implement reduction in crystallization temperature by vapor deposition using a minimum amount of raw material gas in a supercritical state. The present invention may also implement an efficient thin-film forming technology by reducing manufacturing steps by selectively growing a ferroelectric thin film only on a previously processed Pt electrode. According to one aspect of the present invention, there is provided a method of manufacturing an oxide thin film, wherein a supercritical fluid is used as a medium. For example, a ferroelectric thin film can be manufactured by using a mixture obtained by dissolving elements of oxide ferroelectric in a supercritical fluid as a raw material.

### BRIEF DESCRIPTION OF THE SEVERAL VIEWS OF THE DRAWING

FIG. 1 is a diagram showing a conventional method of manufacturing a ferroelectric capacitor.

FIG. 2 is a diagram showing the configuration of a ferroelectric capacitor according to one embodiment of the present invention.

FIG. 3 is a phase diagram showing a supercritical state according to one embodiment of the present invention.

FIG. 4 is a table showing supercritical fluids according to one embodiment of the present invention.

FIG. 5 is a table showing properties of a supercritical fluid according to one embodiment of the present invention.

FIG. 6 is a diagram showing a system for forming a ferroelectric thin film using a supercritical fluid according to one embodiment of the present invention.

FIG. 7 shows surface morphology of a BLT-BSO thin film according to one embodiment of the present invention.

FIG. 8 shows ferroelectric hysteresis curves of a BLT-BSO thin film according to one embodiment of the present invention.

FIGS. 9A and 9B are cross sections showing selective growth properties of BLT-BSO thin films according to one embodiment of the present invention.

FIG. 10 shows surface morphology of an SBT thin film according to one embodiment of the present invention.

FIG. 11 is a graph showing a ferroelectric hysteresis curve of an SBT thin film according to one embodiment of the present invention.

FIG. 12 is a graph showing fatigue characteristics of an SBT thin film according to one embodiment of the present invention.

FIGS. 13A and 13B are graphs showing XRD patterns of PZTN thin films according to one embodiment of the present invention.

FIG. 14 is a graph showing a ferroelectric hysteresis curve of a PZTN thin film according to one embodiment of the present invention.

### DETAILED DESCRIPTION OF THE EMBODIMENTS

According to one embodiment of the present invention, there is provided a method of manufacturing an oxide thin film, wherein a supercritical fluid is used as a medium.

According to one embodiment of the present invention, there is provided a method of manufacturing a ferroelectric thin film, wherein a mixture obtained by dissolving elements of oxide ferroelectric in a supercritical fluid is used as a raw material. According to one embodiment of the present invention, there is provided a method of manufacturing a ferroelectric thin film, wherein amorphous ferroelectric is crystallized after bubbles are dissolved in the amorphous ferroelectric. The bubbles may be formed from supercritical fluid. According to one embodiment of the present invention, there is provided a method of manufacturing a ferroelectric thin film, wherein a low-solubility element is dissolved in a supercritical fluid, and then the dissolved product is added to a ferroelectric raw material. According to one embodiment of the present invention, there is provided a method of manufacturing a ferroelectric thin film, wherein a supercritical fluid pressurized at a pressure ranging from a supercritical pressure to four times the supercritical pressure is used as a solvent. In this method, a ferroelectric thin film may be selectively grown by utilizing difference in characteristics of a material of a previously-patterned substrate; a ferroelectric thin film may be selectively grown by utilizing difference in surface energy of a previously-patterned substrate; or a ferroelectric thin film may be selectively grown by utilizing difference in surface state of a previously-patterned substrate. The ferroelectric thin film may be formed only on an electrode metal. According to one embodiment of the present invention, there is provided a method of manufacturing a ferroelectric thin film, wherein a solvent obtained by dissolving a sol-gel solution including a ferroelectric element in a supercritical fluid is used. According to one embodiment of the present invention, there is provided a method of manufacturing a ferroelectric thin film, wherein a solution obtained by dissolving an oxide including a ferroelectric element in a supercritical fluid is used. According to one embodiment of the present invention, there is provided a method of manufacturing a ferroelectric thin film, wherein a gas-liquid substance obtained by dissolving an oxide including a ferroelectric element in a supercritical fluid is used. According to one embodiment of the present invention, there is provided a method of manufacturing a ferroelectric thin film, wherein a gas obtained by dissolving an oxide including a ferroelectric element in a supercritical fluid is used. As the supercritical fluid, one of H₂, N₂, Xe, CO₂, C₂H₆, CH₃OH₂, NH₃ and H₂O may be used.

According to one embodiment of the present invention, there is provided a ferroelectric thin film which has a perovskite structure and is manufactured by the above method. According to one embodiment of the present invention, there is provided a ferroelectric thin film which has a bismuth-layered structure and is manufactured by the above method. According to one embodiment of the present invention, there is provided a ferroelectric memory device which comprises the above ferroelectric thin film. According to one embodiment of the present invention, there is provided a ferroelectric piezoelectric device which comprises the above ferroelectric thin film.

A ferroelectric memory device according to an embodiment of the present invention includes a first electrode electrically connected with a source electrode or a drain electrode of a CMOS transistor formed on an Si wafer in advance, a ferroelectric film formed on the first electrode, and a second electrode formed on the ferroelectric film. A select operation of a capacitor formed by the first electrode, the ferroelectric film, and the second electrode is performed by the CMOS transistor formed on the Si wafer in advance.

The ferroelectric memory device according to the embodiment of the present invention may include third electrodes formed in advance, fourth electrodes arranged in a direction which intersects the third electrodes, and ferroelectric films disposed at least in intersecting regions of the third electrodes and the fourth electrodes. Capacitors formed by the third electrode, the ferroelectric film, and the fourth electrode are arranged in a matrix.

The ferroelectric film may be formed by using a supercritical fluid which includes the constituent elements of the ferroelectric and is pressurized at a pressure equal to or greater than the critical pressure, but equal to or less than four times the critical pressure.

Embodiments of the present invention are described below in more detail with reference to the drawings.

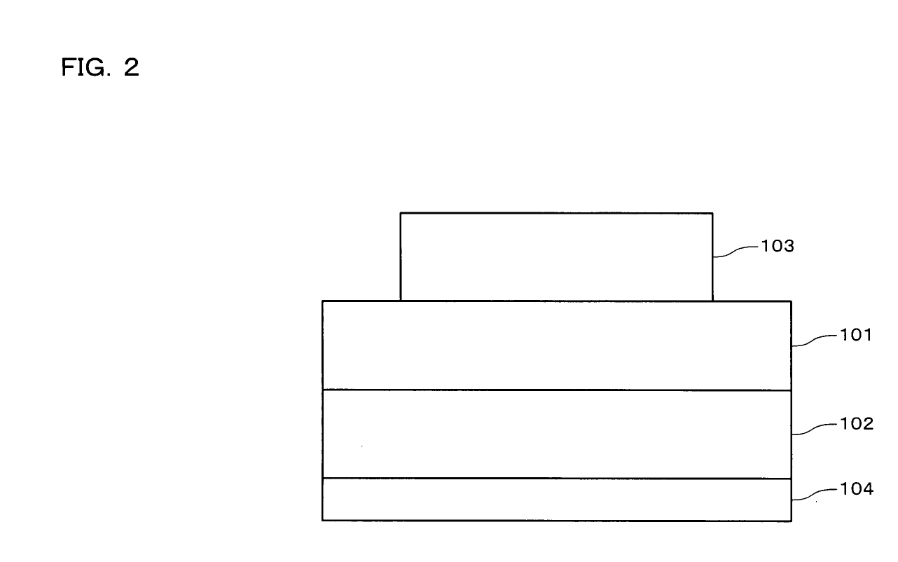

FIG. 2 is a diagram showing a ferroelectric capacitor in the ferroelectric memory device according to one embodiment of the present invention. The ferroelectric capacitor shown in FIG. 2 includes a ferroelectric film 101 formed by using a supercritical fluid, a first electrode 102, and a second electrode 103. The first electrode 102 and the second electrode 103 are formed of a noble metal element such as Pt, Ir, or Ru, or a composite material containing the noble metal as a major component. If the elements of the ferroelectric are diffused into the first electrode 102 or the second electrode 103, squareness of the hysteresis is decreased due to variation of the composition at the interface between the electrode and the ferroelectric film. Therefore, the first electrode 102 and the second electrode 103 must have a density which does not allow the elements of the ferroelectric to be diffused into the first electrode 102 and the second electrode 103. In order to increase the density of the first electrode 102 and the second electrode 103, a method of depositing the electrode by sputtering using a large mass of gas, a method of dispersing an oxide of Y, La, or the like into the noble metal electrode, or the like is employed. Si, Ge, or the like may be used as a material for a semiconductor substrate 104. In FIG. 2, the substrate and other constituent elements (MOS transistors and the like) of the ferroelectric memory device are omitted.

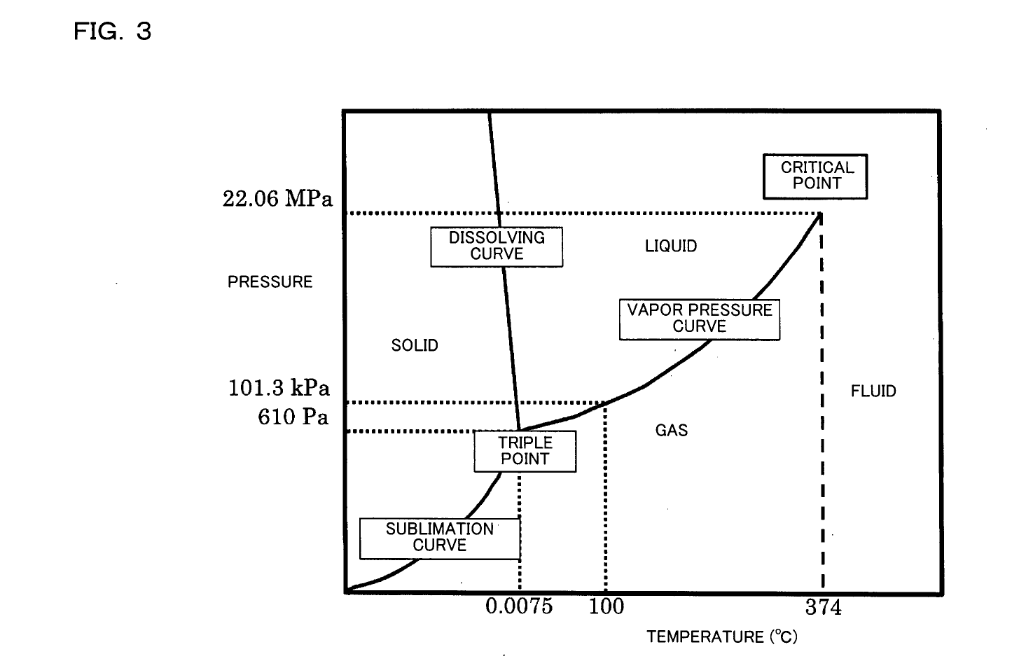

A supercritical fluid is described below. It is known that a substance has three phases called a gas phase, a liquid phase, and a solid phase as shown in the phase diagram of water in FIG. 3. The boundary between the gas phase and the liquid phase is known as a vapor pressure curve, the boundary between the gas phase and the solid phase is known as a sublimation curve, and the boundary between the solid phase and the liquid phase is known as a melting curve, for example.

Water reaches a critical state at 374° C. and 214 atmospheres along the vapor pressure curve. The density of the gas phase and the liquid phase becomes 0.315 g/cm³ at this point, whereby the boundary between the gas phase and the liquid phase disappears. If the temperature or pressure becomes higher than the critical state, the distinction between the gas phase and the liquid phase is lost and water is in a state called fluid. A fluid in a state equal to or higher than the critical state is called a supercritical fluid.

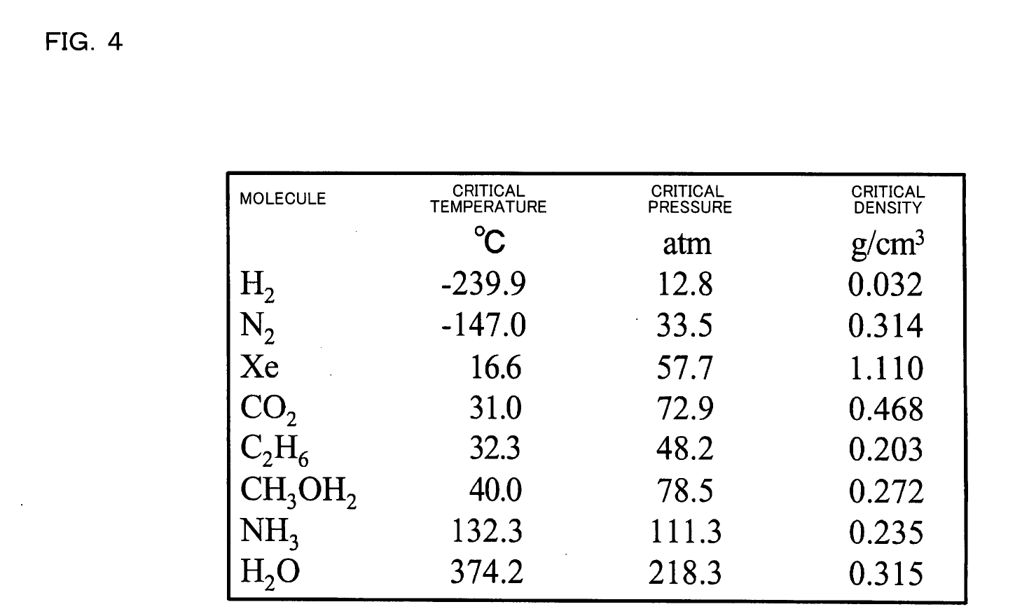

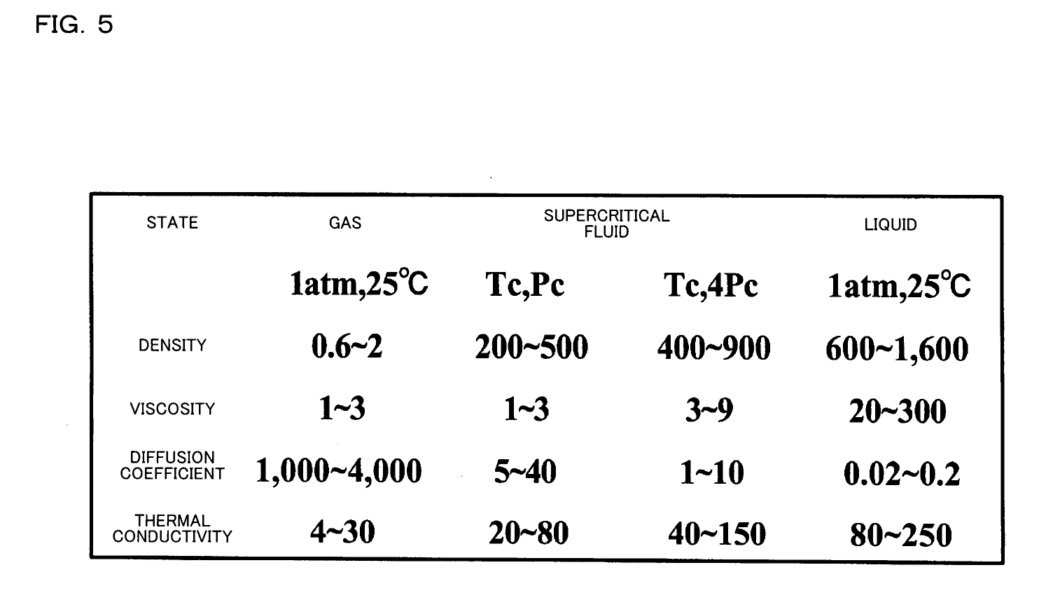

In this embodiment, substances shown in FIG. 4 are used as a supercritical fluid. FIG. 5 shows properties of a supercritical fluid.

Specifically, the supercritical fluid is a substance in a state in which the density is close to that of liquid, the viscosity is close to that of gas, the diffusion coefficient is smaller than that of gas but has a value about 100 times that of liquid, and the thermal conductivity is extremely close to that of liquid. Specifically, the supercritical fluid can be used as an excellent reaction medium, that is, an excellent solvent having high thermal conductivity, high diffusibility, low viscosity, and density equal to that of liquid.

In this embodiment, an oxide thin film is formed by dissolving an oxide raw material in a supercritical fluid and applying the mixture. As the oxide material, a transparent electrode oxide thin film such as 1TO, a perovskite or Bi-layered structure ferroelectric oxide thin film, and the like can be given. In this embodiment, a ferroelectric thin film is formed by dissolving a ferroelectric raw material in a supercritical fluid and applying the mixture.

As the dissolution and application method, a method of immersing a substrate in a supercritical fluid in which a ferroelectric raw material is dissolved, a method of spraying a supercritical fluid in which a ferroelectric raw material is dissolved onto a substrate, and the like can be given.

The supercritical fluid can be controlled and used in an arbitrary form such as a gas phase (at about the critical pressure) and a gas-liquid phase (at about four times the critical pressure), as shown in FIG. 5. As the control parameters, the temperature of the substrate, the pressure of a reaction vessel, and the like may be changed.

Since whether or not the element of the ferroelectric perovskite structure can be replaced is determined by the ionic radius, a large amount of stress which causes the crystal lattice to be distorted is necessary for introducing a small element such as Si. However, since the supercritical state is a pressurized environment, a small element such as Si can be easily introduced into the crystal lattice in this embodiment.

In the case of using a sol-gel solution which has a network formed by polycondensation as the raw material, polycondensation further progresses at the critical pressure. In the case of using an MOD solution which does not have a network formed by polycondensation, the MOD solution is dissolved in the supercritical fluid, but formation of the network does not progress. Therefore, the raw materials can be used depending on the purpose.

A thin film may be grown only in the region to which it is desired that the material partially adhere by utilizing the distribution of the surface energy, the difference in material, the difference in shape, or the like of the adhesion surface on the substrate.

An example of a method of depositing a ferroelectric thin film by using CO₂ as the supercritical fluid is described below. The following description illustrates the case of forming a thin film of a BLT-BSO ferroelectric crystal produced by dissolving Bi₂SiO₅ (BSO) in a (Bi_{3.25},La_{0.75})Ti₃O₁₂ (BLT) crystal formed by replacing a part of Bi in a Bi-layered perovskite Bi₄Ti₃O₁₂ (BIT) crystal with La at a ratio of BLT:BSO=10:4.

A first raw material liquid is a solution in which a polycondensation product for forming a Bi-layered perovskite crystal called B1T formed by Bi, Ti, and O among the constituent metal elements of the BLT-BSO ferroelectric phase is dissolved in a solvent such as n-butanol in an anhydrous state.

A second raw material liquid is a solution in which a polycondensation product for forming an La₄Ti₃O₁₂ metal oxide formed by La and Ti among the constituent metal elements of the BLT-BSO ferroelectric phase is dissolved in a solvent such as n-butanol in an anhydrous state.

A third raw material liquid is a solution in which a polycondensation product for forming a Bi-layered structure paraelectric BSO crystal formed by Bi and Si among the constituent metal elements of the BLT-BSO ferroelectric phase is dissolved in a solvent such as n-butanol in an anhydrous state.

In the case of forming a BLT-BSO ferroelectric using the first, second, and third raw material solutions, the raw material solutions were mixed at a ratio of (first raw material solution):(second raw material solution):(third raw material solution)=3.25:0.75:1.32.

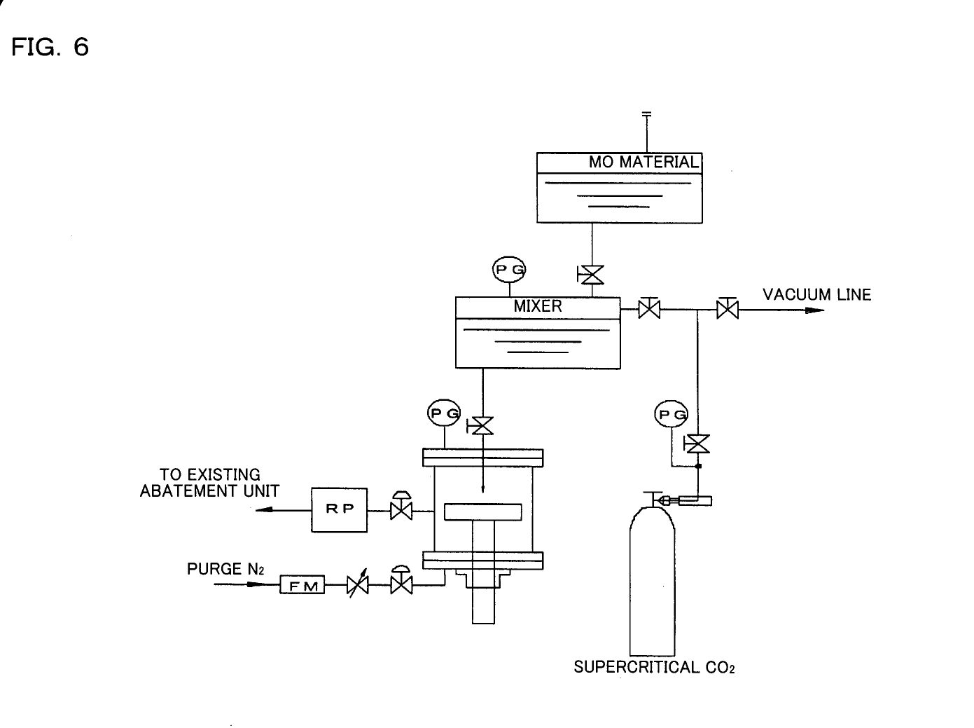

The mixed solution is sealed in a metal organic material container of a supercritical deposition system having a configuration shown in FIG. 6, and introduced into a mixer in an amount of 200 μl. The mixer is filled with CO₂ in a supercritical state pressurized at 75 atmospheres. The mixture is allowed to stand for about 10 min, and sprayed onto a 6-inch Pt coated Si substrate held in a chamber. After removing the substrate from the chamber, the amorphous BLT-BSO formed on the Pt electrode is crystallized into a ferroelectric thin film using RTA or the like.

Detailed examples of the present invention are described below.

### EXAMPLE 1

A BLT-BSO ferroelectric thin film with a thickness of 200 nm was formed on a 6-inch silicon substrate, in which a Pt electrode with a thickness of 200 nm was formed on a wafer, using the above solution in an amount of 200 μl.

As the crystallization conditions, the BLT-BSO ferroelectric thin film was crystallized at 650° C. for 30 min in an oxygen atmosphere using rapid thermal annealing (RTA).

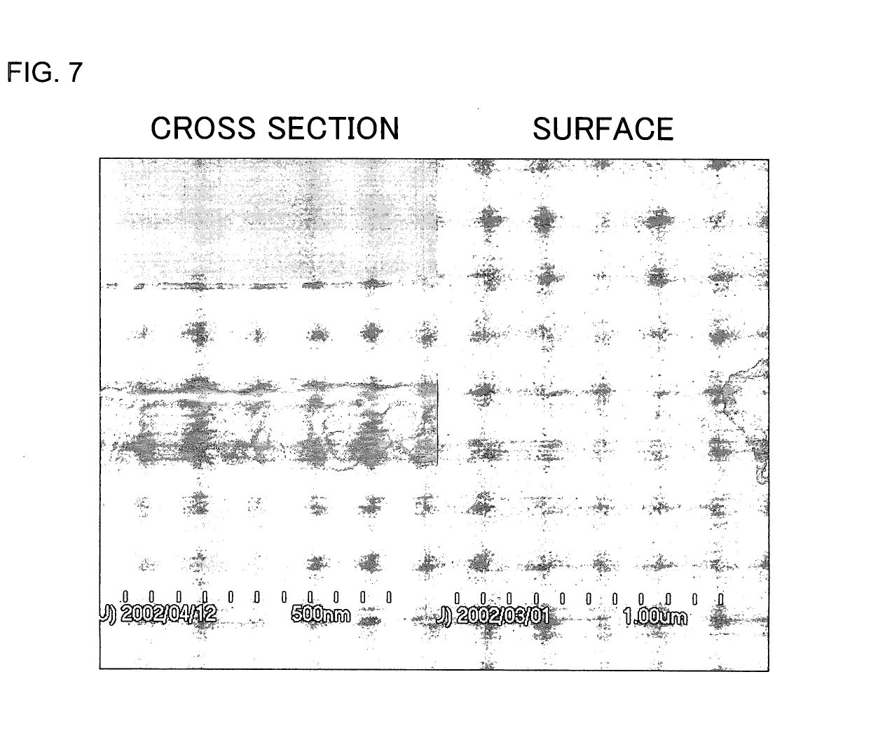

FIG. 7 shows surface morphology and cross-sectional morphology of the resulting thin film.

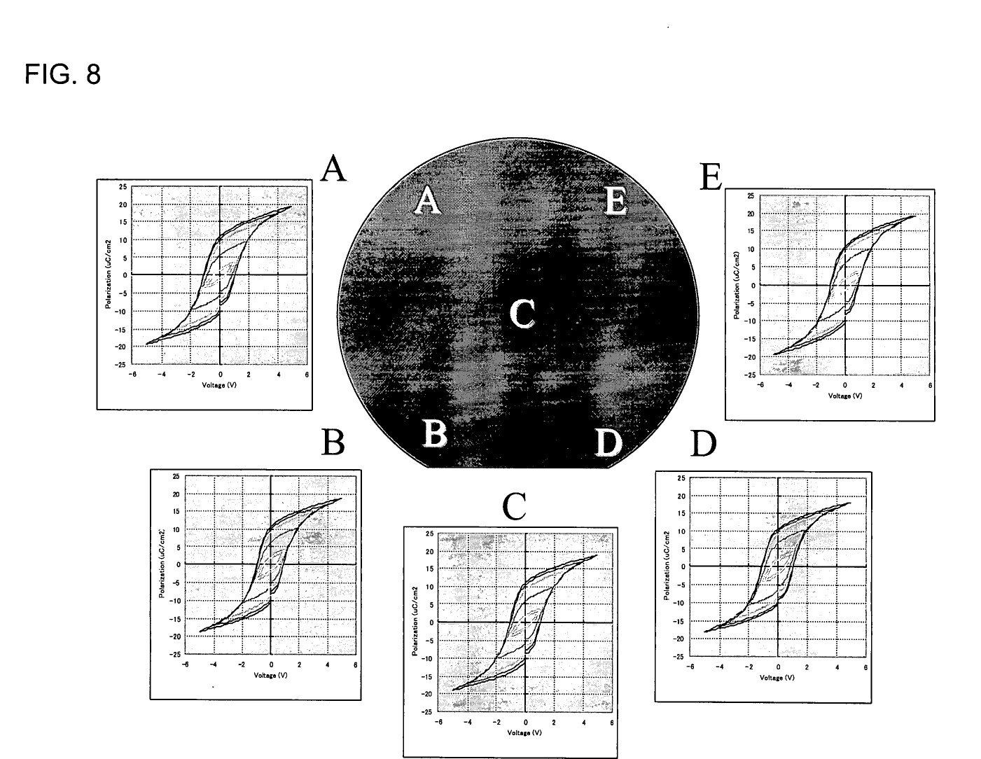

After forming a Pt upper electrode with a diameter of 100 μm and a thickness of 100 nm on the BLT-BSO ferroelectric thin film, the ferroelectric characteristics were evaluated. The results are shown in FIG. 8. According to this example, extremely uniform characteristics were obtained on the entire 6-inch wafer.

A spin coating method using a sol-gel solution has been typically used to form a ferroelectric thin film. In the spin coating method, a sol-gel solution is used in an amount of about 2000 μl in the case of forming a ferroelectric thin film with a thickness of 200 nm on a 6-inch wafer. In the present invention, a ferroelectric thin film with a thickness of 200 nm can be formed by using a raw material solution in an amount of about 1/10 the amount in the spin coating method. A technology which can form a ferroelectric thin film with such a high efficiency using a liquid raw material has not existed.

### EXAMPLE 2

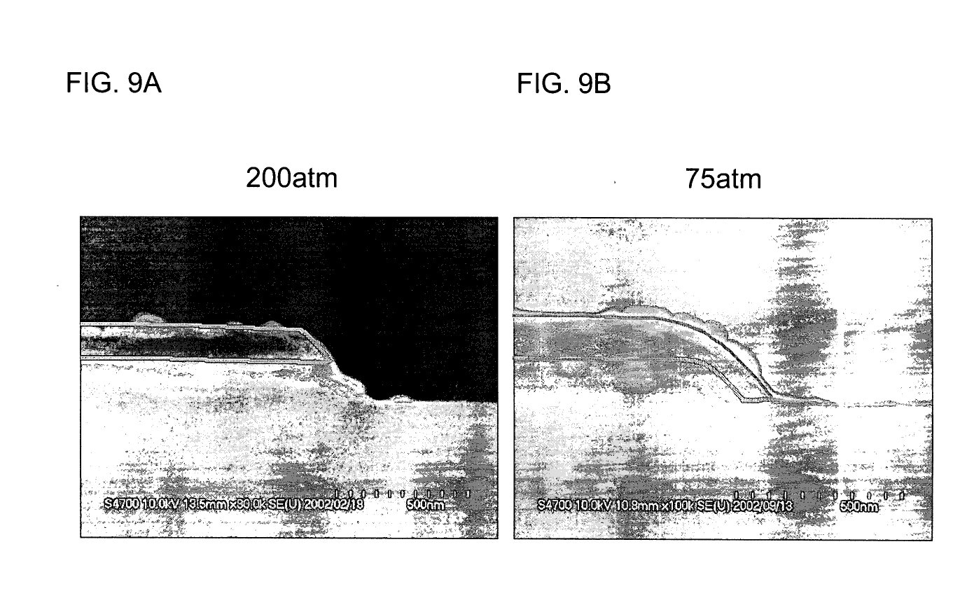

A BLT-BSO ferroelectric thin film was formed on a Pt/SiO₂/Si substrate coated with Pt etched at a width of 1 μm under the same conditions as described above. The solution was introduced again into the mixer in an amount of 200 μl, and a BLT-BSO ferroelectric thin film was formed using CO₂ in a supercritical state which was pressurized at 200 atmospheres. FIGS. 9A and 9B show cross-sectional images of the resulting thin films. In the case of using CO₂ pressurized at 200 atmospheres (FIG. 9A), it was found that the thin film was formed only on the upper part of the Pt. In the case of using CO₂ pressurized at 75 atmospheres (FIG. 9B), it was found that the processed section of the Pt substrate was also covered. In both cases, a thin film was not formed on SiO₂, and the ferroelectric was selectively grown only on the Pt electrode. This suggests that the properties of the supercritical fluid shown in FIG. 5 were applied.

Specifically, since CO₂ pressurized at 75 atmospheres has low viscosity and a large diffusion coefficient, growth of the gas phase is dominant to growth of the liquid phase, whereby the thin film was also formed on the side surface of the Pt. Since CO₂ pressurized at 200 atmospheres has a high viscosity and a small diffusion coefficient, growth of the liquid phase is dominant to growth of the gas phase, whereby the thin film was formed only on the upper part of the Pt. It is known that SiO₂ is hydrophobic. In the case of using a spin coating method, since a solution first collects in a recess section if unevenness exists on the coated surface, it is impossible to prevent the SiO₂ from being covered. However, since the supercritical fluid mainly has the properties of gas although the supercritical fluid has the characteristics of liquid, the material did not adhere to the SiO₂.

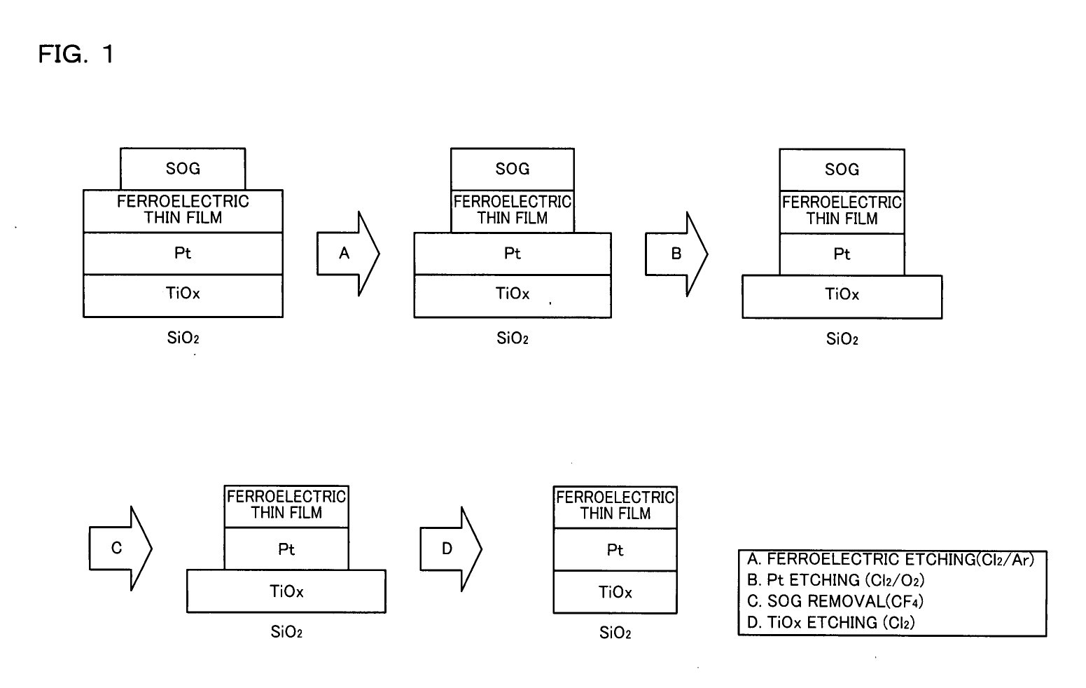

This not only significantly reduces the ferroelectric capacitor formation process in the actual ferroelectric memory manufacturing process shown in FIG. 1, but also enables the capacitor to be formed without etching the ferroelectric. Therefore, the present invention is an epoch-making invention which can prevent deterioration of the characteristics due to process damage.

### EXAMPLE 3

Another ferroelectric thin film was formed. In this example, an SBT ferroelectric was formed. The SBT ferroelectric thin film was formed from SrO, Bi₂O₃, and Ta₂O₅ oxide raw materials. These oxide powders were mixed at a molar ratio of SrO:Bi₂O₃:Ta₂O₅=1:1:1, and 0.1 mol of SiO₂ was further mixed. 25 g of the mixed specimen was placed in the mixer, and CO₂ gas in a supercritical state which was pressurized at 200 atmospheres was sealed in the mixer. The mixture was allowed to stand for 30 min. After the oxide raw materials were fully dissolved, the mixture was applied to a Pt coated Si wafer. The applied mixture was sintered at 600° C. for 60 min in an oxygen atmosphere using RTA. After forming a Pt upper electrode with a diameter of 100 μm and a thickness of 100 nm on the thin film, post annealing was performed at 650° C. for 10 min in an oxygen atmosphere. The electrical properties were then evaluated.

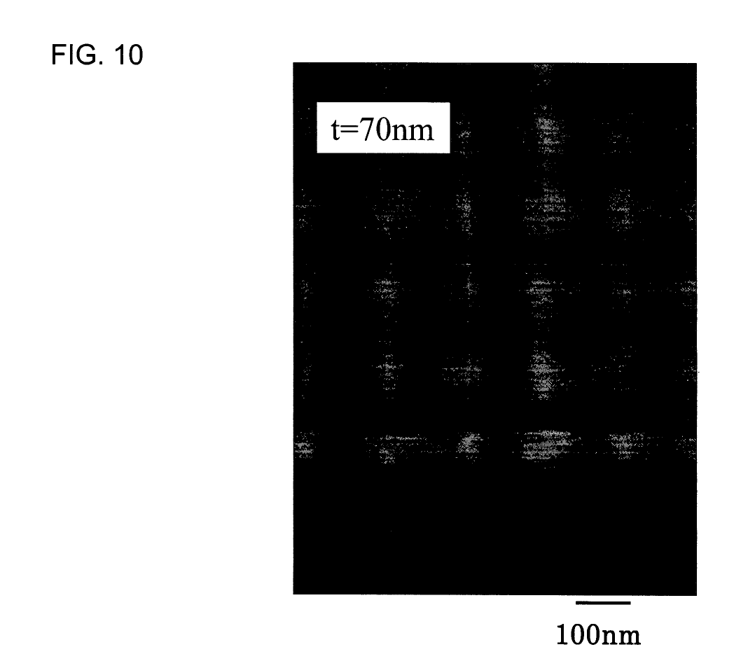

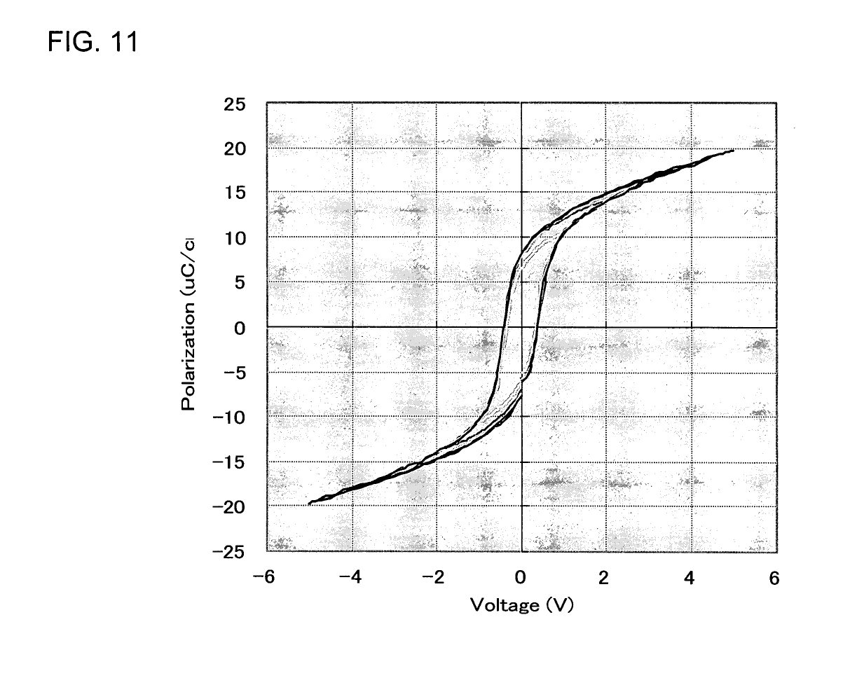

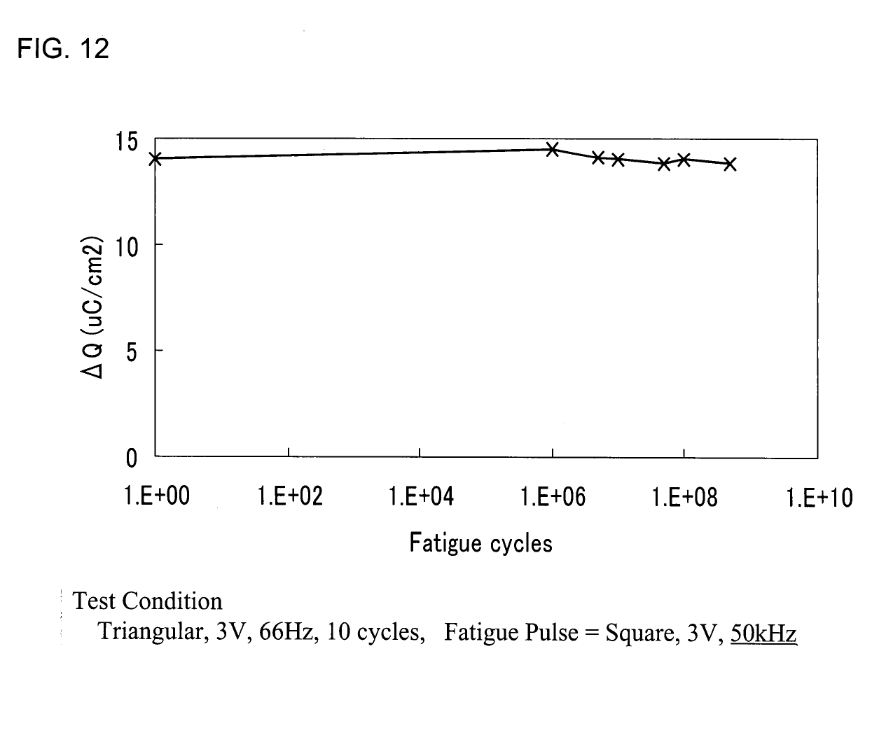

The resulting ferroelectric thin film had excellent surface morphology as shown in FIG. 10, excellent hysteresis characteristics as shown in FIG. 11, and excellent fatigue characteristics as shown in FIG. 12. SBT has a crystallization temperature as high as 700° C. or more. In the case of obtaining the characteristics of SBT at about 650° C., long-time annealing for 10 hours or more is necessary. In particular, high temperature is necessary for obtaining excellent ferroelectric characteristics. However, excellent characteristics were obtained in this example at a temperature as low as 600° C. and a period of time as short as 30 min.

This is the bubble effect due to the supercritical fluid. The raw material solution in which the supercritical fluid is dissolved is at one atmosphere (atmospheric pressure) after deposition. A number of CO₂ bubbles are dissolved in the raw material solution by the same principle as carbonated water.

If the raw material solution is sintered in this state, liquid becomes solid, and an amorphous solid changes into a crystal. A number of bubbles are contained in the amorphous solid. If the entire volume of the bubbles is denoted by V and the entire radius of the bubbles is denoted by r, the surface energy E of the bubbles contained in the amorphous SBT is expressed by E=(3V/r)γ₀ (γ₀ is surface energy at 0 K).

Specifically, the amorphous SBT has extra free energy for the amount of surface energy E in comparison with amorphous SBT containing no bubbles. Since all reactions progress in the direction in which the free energy decreases from the Gibbs theory, the amorphous SBT containing bubbles in this example crystallizes with a lower energy for the amount of surface energy E of the bubbles in comparison with amorphous SBT containing no bubbles. Specifically, the crystallization temperature is decreased by the present invention.

### EXAMPLE 4

200 μl of a sol-gel solution in which a solute mixed at a ratio of Pb:Zr:Ti:Nb=1:0.2:0.6:0.2 was contained in an n-butanol solvent at a percentage of 10 wt %, and Xe supercritical fluid pressurized at 200 atmospheres were placed in the mixer. The mixture was allowed to stand for 10 min. The mixture was then applied to a Pt coated 6-inch Si wafer, and crystallized at 650° C. for 30 min to form a PZTN thin film with a thickness of 200 nm. A Pt upper electrode with a diameter of 100 μm and a thickness of 100 nm was formed on the PZTN thin film, and post annealing was performed at 650° C. for 30 min. The electrical properties were then evaluated.

A PZTN thin film was formed by a conventional spin coating method using the above sol-gel solution in which a solute mixed at a ratio of Pb:Zr:Ti:Nb=1:0.2:0.6:0.2 was contained in an n-butanol solvent at a percentage of 10 wt %. The sol-gel solution was applied four times at a rotational rate of 3000 rpm to form a film with a thickness of 200 nm. The amount of the sol-gel solution required for forming one layer was 500 μl, and 2 cc was necessary for forming four layers. The necessary amount of the solution was ten times that of the present invention. Crystallization was performed at 650° C. for 30 min in an oxygen atmosphere by RTA to form a PZTN thin film with a thickness of 200 nm. A Pt upper electrode with a diameter of 100 μm and a thickness of 100 nm was formed on the PZTN thin film, and post annealing was performed at 650° C. for 30 min. The electrical properties were then evaluated.

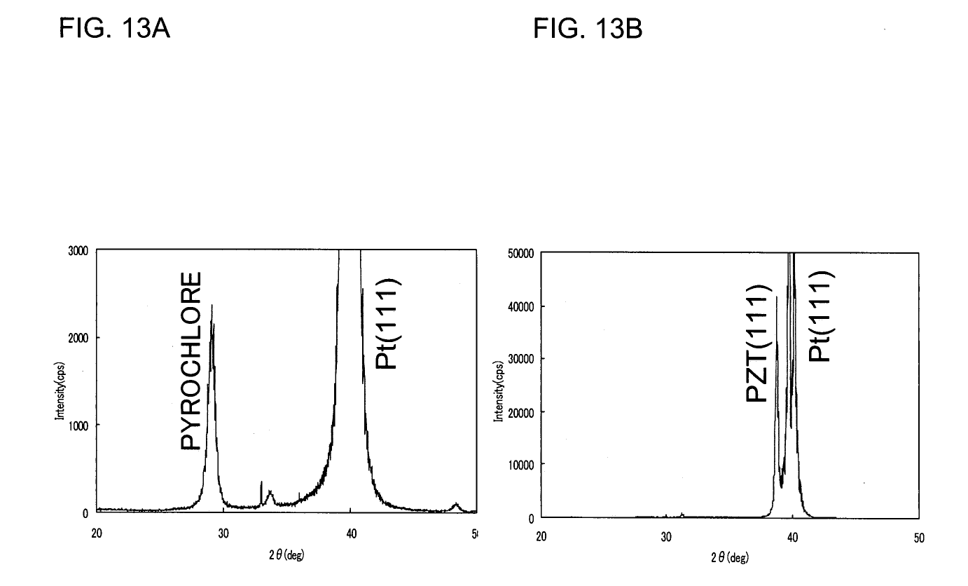

FIGS. 13A and 13B show XRD patterns of the resulting PZTN thin films. In the case of using a conventional spin coating method (FIG. 13A), only a pyrochlore phase, which is a heterophase, was obtained at 650° C. In the case of using the Xe supercritical fluid according to the example of the present invention (FIG. 13B), a (111)-oriented PZTN thin film was obtained.

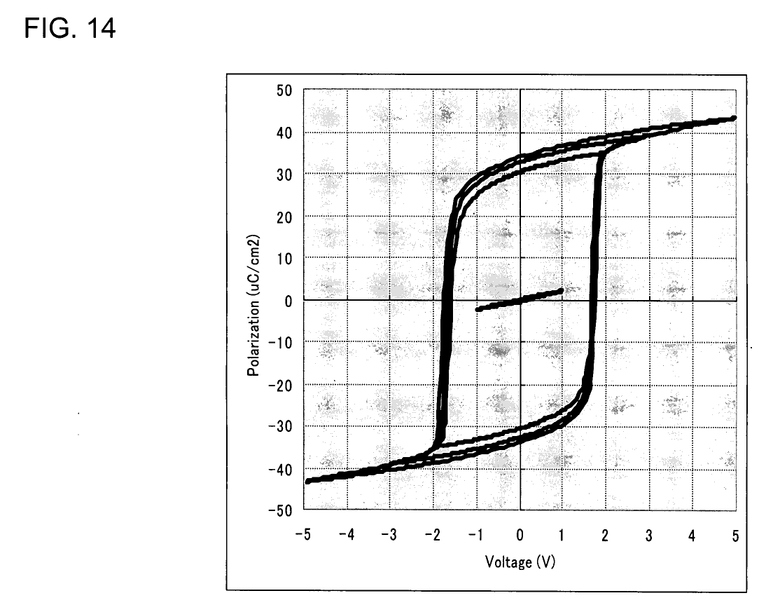

In the case of using a conventional spin coating method, ferroelectric hysteresis was not obtained. However, in the case of the PZTN thin film according to the example of the present invention, excellent hysteresis characteristics as shown in FIG. 14 were obtained. This resulted from the reduction effect of the crystallization temperature due to the Xe supercritical fluid in the same manner as the CO₂ supercritical fluid.

### EXAMPLE 5

In₂O₃ oxide was sufficiently mixed with Sb and Si with a ratio of 3 mol % of Sb and 1 mol % of Si to 1 mol of In₂O₃. After introducing 10 g of the mixture into the mixer, the mixer was filled with CO₂ pressurized at 200 atmospheres. The mixture was allowed to stand for 10 min, and applied to an optical glass (BaK₄) substrate. The applied mixture was subjected to a heat treatment at 200° C. for 20 min in an oxygen atmosphere. As a result, an In₂O₃ oxide thin film including Sb and Si was formed over the entire glass substrate at a thickness of 200 nm. The sheet resistance was 10 Ω/cm²±5%, and the transmittance for light with a wavelength λ of 550 nm was 90%.

After applying a resist over the entire In₂O₃ oxide thin film, holes with dimensions of 100 μm×100 μm were formed lengthwise and widthwise at intervals of 100 μm using a liftoff. Specifically, a resist mask containing holes with dimensions of 100 μm×100 μm was formed on the In₂O₃ oxide thin film. After performing an ozone treatment, the resist was removed.

200 μl of a sol-gel solution in which a solute mixed at a ratio of Pb:Zr:Ti:Nb=1:0.2:0.6:0.2 was contained in an n-butanol solvent at a percentage of 10 wt %, and CO₂ supercritical fluid pressurized at 200 atmospheres were placed in the mixer, and allowed to stand for 10 min. The mixture was applied to the glass substrate on which the In₂O₃ oxide thin film was formed, and crystallized at 650° C. for 30 min to form a PZTN thin film with a thickness of 200 nm. The PZTN thin film was formed by the ozone treatment only in the 100 μm×100 μm region in which the surface energy was higher than the resist mask area.

In₂O₃ oxide was sufficiently mixed with Sb and Si with a ratio of 3 mol % of Sb and 1 mol % of Si to 1 mol of In₂O₃. After introducing 10 g of the mixed oxide into the mixer, the mixer was filled with CO₂ pressurized at 200 atmospheres. The mixture was allowed to stand for 10 min, and applied to the entire surface of the substrate. The applied mixture was subjected to a heat treatment at 200° C. for 20 min in an oxygen atmosphere. As a result, an In₂O₃ oxide thin film was formed only on the PZTN thin film. This is because the surface energy of PZTN is higher than the surface of the In₂O₃ oxide thin film.

Specifically, a PZTN ferroelectric capacitor with dimensions of 100 μm×100 μm was formed on the substrate without using an etching process.

Although embodiments of the present invention are described above, the present invention is not limited to the above-described embodiments. The present invention may be embodied in various modifications within the scope of the present invention.

1. A method of manufacturing an oxide thin film,
wherein a supercritical fluid is used as a medium.

2. A method of manufacturing a ferroelectric thin film,
wherein a mixture obtained by dissolving elements of oxide ferroelectric in a supercritical fluid is used as a raw material.

3. A method of manufacturing a ferroelectric thin film,
wherein bubbles are dissolved in amorphous ferroelectric, and then the amorphous ferroelectric is crystallized.

4. The method of manufacturing a ferroelectric thin film as defined in claim 3,
wherein the bubbles are formed from supercritical fluid.

5. A method of manufacturing a ferroelectric thin film,
wherein a low-solubility element is dissolved in a supercritical fluid, and then the dissolved product is added to a ferroelectric raw material.

6. A method of manufacturing a ferroelectric thin film,
wherein a supercritical fluid pressurized at a pressure ranging from a supercritical pressure to four times the supercritical pressure is used as a solvent.

7. The method of manufacturing a ferroelectric thin film as defined in claim 2
wherein a ferroelectric thin film is selectively grown by utilizing difference in characteristics of a material of a previously-patterned substrate.

8. The method of manufacturing a ferroelectric thin film as defined in claim 2,
wherein a ferroelectric thin film is selectively grown by utilizing difference in surface energy of a previously-patterned substrate.

9. The method of manufacturing a ferroelectric thin film as defined in claim 2,
wherein a ferroelectric thin film is selectively grown by utilizing difference in surface state of a previously-patterned substrate.

10. The method of manufacturing a ferroelectric thin film as defined in claim 2,
wherein a ferroelectric thin film is formed only on an electrode metal.

11. A method of manufacturing a ferroelectric thin film,
wherein a solvent obtained by dissolving a sol-gel solution including ferroelectric elements in a supercritical fluid is used.

12. A method of manufacturing a ferroelectric thin film,
wherein a solution obtained by dissolving an oxide including ferroelectric elements in a supercritical fluid is used.

13. A method of manufacturing a ferroelectric thin film,
wherein a substance in a gas-liquid phase obtained by dissolving an oxide including ferroelectric elements in a supercritical fluid is used.

14. A method of manufacturing a ferroelectric thin film,
wherein a gas obtained by dissolving an oxide including ferroelectric elements in a supercritical fluid is used.

15. A method of manufacturing a ferroelectric thin film,
wherein one of H₂, N₂, Xe, CO₂, C₂H₆, CH₃OH₂, NH₃ and H₂O is used as the supercritical fluid as defined in claim 2.

16. A ferroelectric thin film which has a perovskite structure and is manufactured by the method as defined in claim 2.

17. A ferroelectric thin film which has a bismuth-layered structure and is manufactured by using the method as defined in claim 2.

18. A ferroelectric memory device comprising the ferroelectric thin film as defined in claim 16.

19. A ferroelectric piezoelectric device comprising the ferroelectric thin film as defined in claim 16.

20. A ferroelectric memory device comprising the ferroelectric thin film as defined in claim 17.

21. A ferroelectric piezoelectric device comprising the ferroelectric thin film as defined in claim 17.
